(19) United States
(12) Patent Application Publication
(10) Pub. No.: US 2002/0111395 A1
(43) Pub. Date: Aug. 15, 2002

(54) Ink, ink cartridge storing said ink and recording device using said ink

(76) Inventors: Yuzo Horikoshi, Kawasaki-shi (JP); Katura Sakamoto, Kawasaki-shi (JP); Norio Sawatari, Kawasaki-shi (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/492,373

(22) Filed: Jan. 27, 2000

(30) Foreign Application Priority Data
Jan. 28, 1999 (JP) 11-019957

(51) Int. Cl. C03C 17/00; C09D 5/00

(52) U.S. Cl. 523/160; 523/161

(57) ABSTRACT

The present invention aims to provide such ink that is less blurred (i.e., more rapid-drying) when printed on a universal recording medium, easier to be fixed on the recording medium and capable of forming a higher quality image satisfactorily reproducing an original image color than conventional ink, an ink cartridge storing the ink, and a recording device utilizing the ink. The ink of the present invention comprises a primary particle of a copolymer obtained from at least one kind of a radical polymeric monomer, a colorant and a solvent that is liquid at room temperature.

### BACKGROUND OF THE INVENTION

The present invention relates to ink, and in particular to printing ink used for a recording device such as a printer.

The ink of the present invention is preferably applicable to a piezo-type inkjet head in which a piezoelectric element is used for a print head or a film-boiling-type (or bubble-type) inkjet head, and can widely be employed not only for a discrete printer (inkjet printer), but also for a copier, a facsimile, a computer system, word-processor, or the combination thereof which has a printing function.

The inkjet printer is currently in increasing demand due to its excellence in silent operation and easiness to achieve a full-color printing. In particular, the drop-on-demand inkjet head that ejects ink droplets from an inkjet nozzle only when necessary in printing operation has become widely used.

Among inkjet heads, those using a piezoelectric element (i.e. piezo-type inkjet head) have increasingly come into the limelight in recent years for their high energy-efficiency, etc. This kind of inkjet head typically includes a piezoelectric element, one common ink chamber which receives from an external device and stores ink, a plurality of pressure chambers connected to the piezoelectric element and a nozzle plate connected to the pressure chambers so that a nozzle may be connected to each pressure chamber. Each pressure chamber is connected to the common ink chamber through an ink supply channel so that it may receive ink from the common ink chamber and increase an internal pressure by utilizing a deformation of the piezoelectric element, thereby ejecting ink from each nozzle.

Other than the piezo-type inkjet head, those using a so-called bubble-type (film-boiling-type) ink ejecting means are known too.

The ink employed for the drop-on-demand printer is aqueous ink that includes water (solvent) and colorant as main constituents and is prepared by adding polyhydric alcohol, e.g., ethylene glycol and diethylene glycol as a wetting agent in order to prevent a nozzle from clogging. The ink droplets ejected from the nozzle, after reaching a recording medium, immediately penetrates and gets dry, forming an image.

In conventional aqueous ink, however, the colorant dissolves in the solvent and penetrates together with the solvent into a recording medium, spreading in the medium. When the colorant spreads in the recording medium, the printed image blurs; therefore, the conventional aqueous ink cannot form a high quality image. Especially, the more time it takes for ink to penetrate until getting dry, the wider the blur spreads. The blur also. reduces the image density (and accordingly poorly reproducing an original color).

In order to avoid such a blur while using aqueous ink, it has been proposed to employ a recording medium having a special ink absorption layer (surface coating layer). Such a recording medium would serve to form a high quality image, but disadvantageously make a manufacturing cost expensive. In addition, this method does not form a high quality image, for example, on universal regular office paper.

Alternatively, in order to obtain a good image regardless of kinds of recording media, it has been proposed to employ phase-change ink that is in a solid state at room temperature and becomes liquid when heated. Since the phase-change ink in a liquid state, once ejected on a recording medium, is cooled on the recording medium and becomes solid, the ink (or the colorant thereof) does not nearly or almost never penetrate into the recording medium, so that the phase-change ink is able to provide a high quality image without a blur.

However, the phase-change ink, which conventionally includes a low-molecular wax as a main constituent, is likely to crystallize at room temperature, whereby, for example, an ink layer of a recorded image is liable to crack when the recorded image is bent, and is hard to be fixed. In addition, as ink dots recorded on the recording medium do not nearly or almost never penetrate into the recording medium, for example, a strong rub given to the recorded image with a finger would exfoliate contact surfaces of the recording medium and the ink layer, and disfigure the image. Furthermore, the small-molecular wax is so soft at room temperature that a slight scratch by fingernail on the surface may cause cracks, deteriorating the image.

Consequently, conventionally proposed ink could not provide inexpensively a high quality image satisfactorily reproducing an original image color while maintaining both rapid-drying (i.e., less blurred) and fixative properties.

### BRIEF SUMMARY OF THE INVENTION

Accordingly, it is a general object of the present invention to provide novel and useful ink, an ink cartridge storing the ink, and a recording device utilizing the ink in which the above disadvantages are eliminated.

More specifically, it is an exemplified object of the present invention to provide such ink that is less blurred (i.e., more rapid-drying), easier to be fixed on a recording medium and capable of forming a higher quality image satisfactorily reproducing an original image color than conventional ink, as well as provide an ink cartridge storing the ink, and a recording device utilizing the ink.

Moreover, it is another object of this invention to provide more stably storable ink than conventional ink, as well as provide an ink cartridge storing the ink, and a recording device utilizing the ink.

In order to achieve the above objects, the ink of the present invention comprises a copolymer particle (preferably a primary particle of a copolymer) obtained from at least one kind of a radical polymeric monomer, a colorant and a solvent that is liquid at room temperature.

The ink cartridge of the present invention includes a case and ink which is stored in the case and comprises a copolymer particle obtained from at least one kind of a radical polymeric monomer, a colorant and a solvent that is liquid at room temperature.

The recording device of the present invention is a recording device that includes a head, which is preferably a piezo-type inkjet head, and an ink tank supplying ink to the head, wherein the ink comprises a copolymer particle obtained from at least one kind of a radical polymeric monomer, a colorant and a solvent that is liquid at room temperature.

According to the ink, ink cartridge and recording device of the present invention, the colorant is not dissolved in the solvent due to the copolymer particle. More specifically, the colorant is dissolved/dispersed in the copolymer, is adsorbed onto/coats the surface of the copolymer, or is dispersed at random with the copolymer in the solvent. Consequently when the ink is applied to the recording medium that is in general use, the solvent penetrates into the recording medium but the colorant does not penetrate into the recording medium, therefore producing no blur.

On the other hand, the copolymer particle and the colorant remaining on the surface of the recording medium thereafter combines to form a filmy shape and is stably fixed on the recording medium. This film shaping begins automatically (usually at room temperature) when the solvent penetrates into the recording medium (self-film-shaping), and in this point, the ink of the present invention is strikingly different from conventional phase-change ink. The self-film-shaping property of the inventive ink makes the recording device capable of omitting fixing mechanism and of simplifying its structure.

In this invention, it is preferable to use a primary particle as a copolymer particle. The copolymer particle has the effect of dispersing a resin that is hard to disperse; that is, “a primary particle of a copolymer” is typically a resin particle including a copolymer as a main constituent and a diagrammatically spherical particulate that does not flocculate or associate with one another but is uniformly dispersed. The primary particle may be colored or may not be colored by the colorant.

The primary particle of the copolymer may be prepared by a polymerization process selected from the group consisting of an emulsion polymerization, a micro emulsion polymerization and a soap-free polymerization. The copolymer particle prepared by these processes is covered with a surfactant at its surface. Accordingly, for example, an electrostatic repulsion a steric hindrance or the like occurs among particles, so that the particles are not secondarily flocculated or precipitated even during long-term storage. In other words, the copolymer particle stably disperses in the solvent, therefore having superior storage stability. It goes without saying that a process of covering the surface of the copolymer with the surfactant is not restricted to the foregoing.

Other objects and further features of the present invention will become readily apparent from the following description and accompanying drawings.

### BRIEF DESCRIPTION OF DRAWINGS

FIG. 1 is a schematic perspective view of an inkjet printer to which an inkjet head of the present invention is applicable.

FIG. 2 is a diagrammatic illustration for explaining contrastively: a state in which ink of the present invention reaches a recording medium, and a state in which aqueous ink of the prior arts reaching a recording medium.

FIG. 3 is a diagrammatic representation showing a state of ink of the present invention in an ink tank, illustrating that colorants dissolve or disperse in copolymers.

FIG. 4 is a diagrammatic representation showing a state of ink of the present invention in an ink tank, illustrating that colorants are adsorbed on or coat surfaces of copolymers.

FIG. 5 is a diagrammatic representation showing a state of ink of the present invention in an ink tank, illustrating that colorants together with copolymer particles dissolve in a solvent.

### DETAILED DESCRIPTION OF THE INVENTION

With reference to the attached drawings, an inkjet printer 1 to which ink of the present invention is applied will now be explained. In each drawing, those elements designated by the same reference numeral denote the same elements, and a duplicate description thereof will be omitted. Those elements designated by the same reference numeral with a variety of alphabetical letters attached thereto denote the same kinds of elements but are distinguished from each other by alphabets and are comprehensively designated by simple reference numerals.

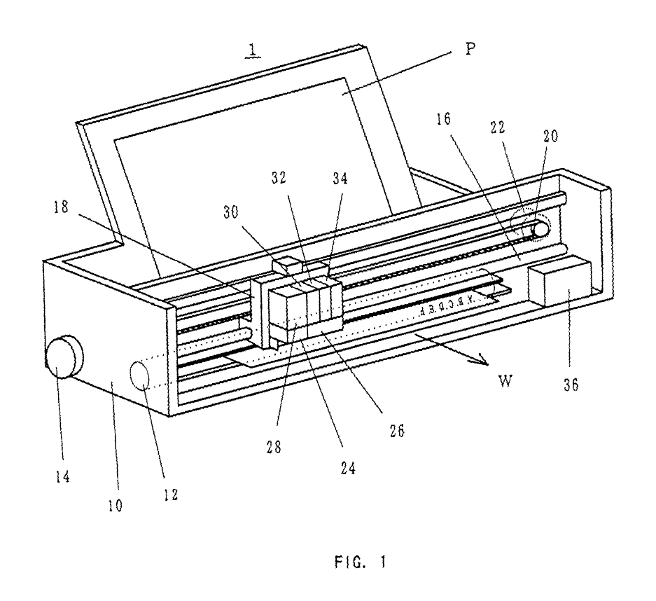

In FIG. 1, there is schematically shown an embodiment of a color inkjet printer (recording device) 1 which may employ ink of the present invention that will be specifically described later. A platen 12 is rotatably provided in a housing 10 of the recording device 1.

In a recording operation, the platen 12 is driven and intermittently rotated by a drive motor 14; thereby, recording paper P is fed intermittently at a predetermined feed pitch in arrow direction W. The housing 10 of the recording device 1 also includes a guide rod 16 above and parallel to the platen 12, and a carriage 18 is slidably attached onto the guide rod 16.

The carriage 18 is attached to an endless drive belt 20 that is driven by the drive motor 22, whereby the carriage 18 is reciprocated (scanned) along the platen 12.

The carriage 18 is mounted with a recording head 24 for a black color and a recording head 26 for multiple colors. The recording head 26 for multiple colors may be comprised of three parts. The recording head 24 for a black color is detachably mounted with a black ink tank 28, while the recording head 26 for multiple colors is detachably mounted with color ink tanks 30, 32 and 34.

The black ink tank 28 stores black ink of the present invention, whereas the color ink tanks 30, 32 and 34 respectively store yellow ink, cyan ink and magenta ink of the present invention.

While the carriage 18 reciprocates along the platen 12, the recording head 24 for a black color and the recording head 26 for multiple colors are driven based upon image data obtained from a word-processor, a personal computer, etc., thereby recording given characters, images, etc. on the printing paper P. When the recording operation ends, the carriage 18 returns to a home position, where a nozzle maintenance mechanism (backup unit) 36 is provided.

The nozzle maintenance mechanism 36 includes a movable suction cap (not shown) and a suction pump (not shown) connected to this movable suction cap. When the recording heads 24 and 26 are placed at the home position, the suction cap is adsorbed to a nozzle plate of each recording head, and the suction pump is driven and thereby sucks nozzles of the nozzle plate. This mechanism prevents the nozzle from being clogged.

Since the ink 100 of the present invention has a self-fixing capability as will be described later, a printer 1 of the present invention may have no fixing mechanism.

A primary particle of a polymer having polarity of the present invention is a resin particle of a thermoplastic copolymer having a thickness of 0.01 through 2 μm or preferably of 0.05 through 1 μm in volume average particle diameter, and is obtainable by a process such as an emulsion polymerization, a micro emulsion polymerization and a soap-free polymerization, etc. The copolymer prepared by the above process, which extremely stably disperses in a solvent, is not secondarily flocculated or precipitated even during long-term storage, therefore, having superior storage stability.

A glass transition point of the copolymer is preferably at or below 70° C. and further preferably ranges from −30 through 70° C. A softening point of the copolymer according to a flow tester is preferably at or below room temperature and further preferably ranges from 40 through 150° C. The reason why the above glass transition point and softening point are preferable is that the primary particle of a polymer after the ink reached on the recording medium forms a thin film shape and a recording layer of high color saturation (i.e., high quality image). If the glass transition point and softening point were higher than the above range, a sufficient film could not be formed whereby the color saturation might become lower (poorly reproducing its original image color) or an ink film might exfoliate (making the image harder to be fixed). If the glass transition point and softening point were lower than the above range, a film of insufficient strength could, for example, undesirably result in producing a blur of the image when rubbed with a finger (making the image harder to be fixed).

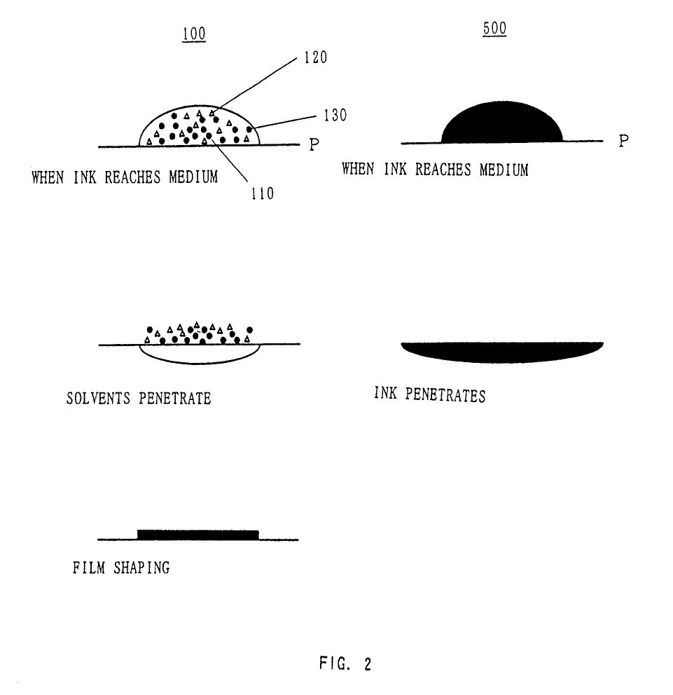

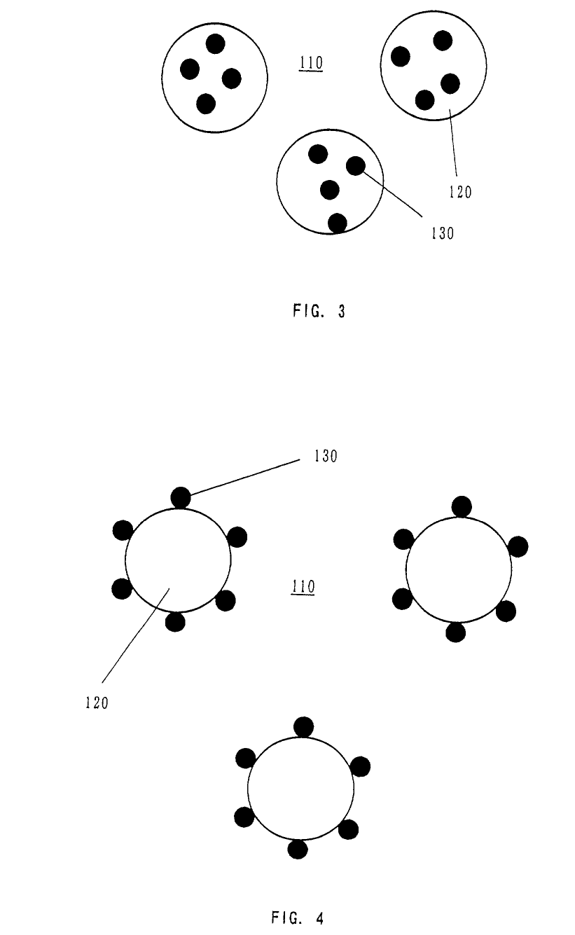

Next, a description will be given to a state in which the ink 100 of the present invention reaches a recording medium P in comparison with a state in which aqueous ink 500 of the prior arts reaching a recording medium P with reference to FIGS. 2 through 5. FIGS. 3 through 5 are diagrammatic representations showing ink in the ink tanks (e.g., the above ink tanks 28, 30, 32 and 34).

The ink 100 of the present invention shown at the left in FIG. 2 comprises a solvent 110 which is in a liquid state at room temperature such as water, a wetting agent (organic solvent) or the mixture thereof, a copolymer particle 120 such as a resin latex, and a colorant 130 such as a pigment or a dye. The ink 100 of the present invention, as will be described more in detail in the below-mentioned embodiment, is obtainable by mixing these materials uniformly with a disperser e.g. a bead mill.

Water, etc. may be used as the solvent 110, and as necessary may be mixed with a wetting agent, such as an alcohol such as ethanol, propanol, ethylene glycol, diethylene glycol, glycerin, butanediol, neopentyl glycol, etc., a higher fatty acid such as oleic acid, linoleic acid, palmitic acid, stearic acid, etc., an ester solvent, a ketone solvent, an aldehyde solvent, a normal paraffin solvent, an isoparaffin solvent. Alternatively, the above-said solvents solely can be used as a solvent 110.

Since the copolymer 120 is prepared by a process such as an emulsion polymerization, a micro emulsion polymerization and a soap-free polymerization, its surface is covered with a surfactant. Accordingly, for example, an electrostatic repulsion a steric hindrance or the like occurs among particles, so that the particles are not secondarily flocculated or precipitated even during long-term storage. As the main constituents of the ink 100 include the solvent 100, it is possible to form an image in a similar treatment as ink used in a conventional inkjet head.

More specifically, the copolymer 120 used for the present invention can be prepared, for example, by the following process. An aqueous solution in which a polymeric monomer having at least one kind of polar group and water, an initiator, e.g., azobisisobutynitril, a nonionic emulsifier, e.g., emulgen 950, and an anionic emulsifier, e.g., neogen, are dissolved is emulsified for thirty minutes by a high-speed shearing disperser, to form a white emulsion. Subsequently a latex of which a primary particle of a copolymer is approximately 0.01 through 1 μm in volume average diameter is obtained by polymerizing for eight hours at a temperature of 80° C. in a flask in a nitrogen atmosphere and thereafter cooling the reactant.

With the colorant 130, the ink 100 of the present invention becomes capable of a black-and-white printing, a multiple-color printing and a full-color printing. The colorant which can be used includes an inorganic filler pigment, e.g., carbon black, colcothar, titanium white, calcite, ferrite, magnetite, etc., an acid dye, an basic dye, a direct dye, a solvent dye, a disperse dye and an oil color, etc., and an organic pigment. A carbon, a titanium white, a solvent dye, a disperse dye, an oil color and an organic pigment are particularly preferable because they easily disperse in a resin latex and form a high-saturation recording layer. The colorant content in the whole of ink may typically be in the range of 0.1 through 30% by weight and preferably in the range of 0.1 through 20% by weight.

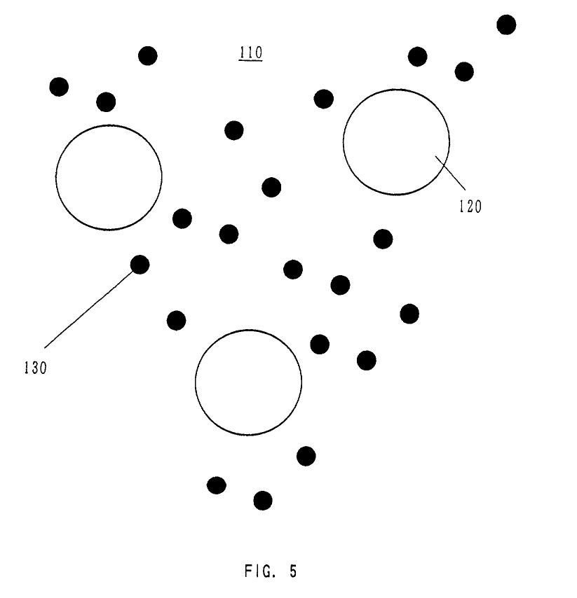

The copolymer particles 120 and colorants 130 may be in several states shown in FIGS. 3 through 5. The state as shown in FIG. 3 indicates that the colorants 130 are dissolved (the colorants 130 are liquefied into the copolymer particles 120 beyond the molecular level) or dispersed (the colorants 130 are mixed with the copolymer particles 120 but remain at the molecular level to some extent). The state as shown in FIG. 4 indicates that the colorants 130 are adsorbed onto the copolymer surfaces (the particles of the colorants 130 are adhered to the film of the copolymer particles 12 at their surfaces by an electronic effects, etc.) or coats the surfaces (the particles of the colorants 130 completely covers the surfaces of the copolymer particles 120). The state as shown in FIG. 5 indicate that the colorants 130 are dispersed at random with the copolymer particles 120 in the solvent 110. In order to prepare ink in which the colorants 130 are dissolved or dispersed in the resin latex 120, the colorants may be added in the process of manufacturing the resin latex.

Accordingly, it is to be construed that the colorants 130 are only mixed and not dissolved in the solvent 110. In this point, it is strikingly different from the ink 500 shown at the right in FIG. 2 in which the colorants are dissolved in the solvent.

When the ink 100 reaches the recording medium P, the ink droplets adhere to the surface of the recording medium P in a plano-convex lens shape as shown at the upper left in FIG. 2. Then, the solvent 110 penetrates into the recording medium P but the copolymer particles 120 and colorants 130 remain and accumulate on the surface of recording medium P without penetrating into the recording medium P as shown at the middle left in FIG. 2. Since the colorants 130 never penetrate into the recording medium, it is possible to form a high-saturation, high-quality image without producing any blurs on the recording medium P.

Further, the copolymer particles 120 and the colorants 130 on the surface of the recording medium P gradually change into a filmy shape and are stably fixed on the recording medium P as a uniform recording layer having no particle surface. The recording layer of one recording medium P, once shaped like a film, never transfers at the back of another recording medium P that is superposed thereon, and the image never becomes disfigured even when the recording layer is lightly rubbed with a finger. The copolymer particles contact one another and are fused together, whereby such a filmy shape is formed automatically at room temperature for a short time (self-film-shaping). The ink 100 of the present invention is strikingly different from conventional phase-change ink in its stably fixing capability. In other words, this self-film-shaping property gives the ink of the present invention a self-fixing capability. Thus, a recording device such as a printer that uses the ink of the present invention needs no fixing mechanism, and therefore enabling structural simplification, downsizing and manufacturing cost reduction.

On the other hand, in the conventional ink 500, after the droplets reach the recording medium P as shown at the upper right in FIG. 2, the solvent and the colorants both penetrate into the recording medium P, which makes dots larger and is likely to produce blurs. Moreover, a high-saturation recording layer may not be obtainable, while an original color may not be satisfactorily reproduced.

When the ink 100 of the present invention is applied to the above-mentioned inkjet heads 24 and 26, in order to stably eject ink droplets from the nozzle, the viscosity of ink should preferably range from 1 through 50 cP, and more preferably from 1 through 30 cP. To make the viscosity of ink like this, the copolymer content in the whole of ink may typically be in the range of 1 through 50% by weight and preferably in the range of 0.1 through 20% by weight.

It is preferable to use the copolymer characterized in being synthetically prepared from at least one kind of radical polymeric monomer having a polar group selected from (a) styrene and styrene derivative, (b) alkyl acrylate, alkyl metacrylate and derivatives thereof. This is because it is easy to adjust its softening point, etc. Further, it is preferable to use the copolymer in which the content of the styrene or the styrene derivatives in the whole copolymer is in the range of 20 through 99% by weight. This is because it is easy to keep the softening point and the glass transition point within a certain range. Furthermore, it is preferable to make the content of the alkyl acrylate, alkyl metacrylate or derivatives thereof in the whole copolymer range from 10 through 80% by weight. This is also because it is easy to keep the softening point and the glass transition point with in a certain range.

The ink 100 of the present invention can be used not only for the piezo-type inkjet heads 24 and 26 but also any bubble-type inkjet heads (not shown). Any configurations that are known in the art may be applied to the bubble-type inkjet head, and detailed description will be omitted. The bubble-type inkjet head has a limitation on kinds of usable solvent for forming bubbles, and therefore the ink 100 of the present invention is preferably applied to the piezo-type inkjet head having no limitation thereon.

The invention will be clarified more specifically by the following examples and a comparative example, which is not intended to limit the scope of the present invention.

### EXAMPLE 1

Preparation of Copolymers Including Acid Polar Groups

| | |
|---|---|
| Styrene monomer (St) | 60 wt % |
| Butyl acrylate (BA) | 40 wt % |
| Acrylic Acid (AA) | 7 wt % |

The mixture of the above monomers was added to the aqueous solution of:

| | |
|---|---|
| Water | 100 wt % |
| Emargen 950 | 1 wt % (emulsion) |
| Neogen R | 1.5 wt % (emulsion) |
| Potassium persurfate | 0.5 wt % (initiator), |

agitated and polymerized at 70° C. for eight hours, a resin latex with a solids content of 50% was obtained. The volume average particle diameters were measured with Microtrac UPA (Nikkiso Co., Ltd.) and turned out to be 0.2 μm. A part of the resin latex was sampled, filtered with the Buchner funnel, washed in the water and vacuum-dried at 50° C. for ten hours. The glass transition point was measured with SSC/5200 (Seiko Instruments Inc.) and turned out to be 45° C., while the softening point was measured with Flow Tester (Shimadzu Corporation) and turned out to be 137° C.

Preparation on Inkjet Ink

| | |
|---|---|
| Resin emulsion including acid polar groups | 50 wt % |
| Phthalocyanine blue pigments | 25 wt % |
| Diethylene glycol | 25 wt % |

The above materials were agitated and uniformly mixed for two hours with DISPERMAT SL-12 (Summit Chemtec Co., Ltd.). The liquid dispersion obtained through this process was then diluted with water of 400 wt %, and consequently inkjet ink was obtained. The viscosity of the ink was measured with DIGITAL VISCOMETER DVM-E (Tokimec Inc.) and tuned out to be 10 cP.

When the above ink was filled into an ink-on-demand inkjet printer (nozzle diameter: Φ40 μm, number of nozzles: 24) similar to the printer 1 and inkjet recordings were executed, little-blurred high-density images were obtained. The results are shown in Tables 1 and 2.

TABLE 1

| | PROPERTIES |
|---|---|
| RESIN LATEX | Particle |

| | | | (Meth)acrylic | | Other | | dia- | Tg | |
|---|---|---|---|---|---|---|---|---|---|
| | | St | ester | | monomer | | meter | ° C. | Tm |
| Exam- | 1 | 60 | BA | 40 | AA | 7 | 0.2 | 45 | 137 |
| ple | 2 | 40 | 2EHA | 60 | MAA | 10 | 0.1 | 10 | 63 |
| | 3 | 60 | BA | 40 | BQA | 7 | 0.3 | 40 | 85 |
| | 4 | 40 | 2EHA | 60 | VP | 5 | 0.2 | 10 | 55 |
| | 5 | 60 | BA | 40 | AA | 7 | 0.5 | 42 | 85 |
| | 6 | 80 | 2EHA | 13 | MAA | 7 | 0.08 | 65 | 127 |
| | 7 | 60 | BA | 40 | BQA | 5 | 0.1 | 38 | 89 |
| | 8 | 70 | LMA | 40 | DMPC | 10 | 0.05 | 15 | 145 |

| | | | | | | | |
|---|---|---|---|---|---|---|---|
| Com- | 1 | — | — | — | — | — | — |
| parative | | | | | | | |
| Exam- | | | | | | | |
| ple | | | | | | | |

TABLE 2

| | | | | | EVALUATION | | |
|---|---|---|---|---|---|---|---|
| | | INK COMPOSITIONS | | | Color | Fixing | Rapid-drying |
| | | Copolymer | Colorant | Solvent | reproduction | capability | (Blur) |
| Example | 1 | 50 | 25 | 425 | Good | Good | Good |
| | 2 | 50 | 25 | 425 | Good | Excellent | Good |
| | 3 | 50 | 25 | 425 | Good | Good | Good |
| | 4 | 50 | 25 | 425 | Good | Good | Good |
| | 5 | 20 | 50 | 430 | Good | Good | Good |
| | 6 | 100 | 50 | 350 | Good | Excellent | Good |
| | 7 | 20 | 10 | 400 | Good | Good | Good |
| | 8 | 37.5 | 12.5 | 425 | Good | Good | Good |
| Comparative | 1 | — | 25 | 425 | Not good | Good | Not |
| Example | | | | | | | good |

In examples 1 to 8 inclusive, the color reproduction quality (image density) was evaluated as follows. The image density of a solidly shaded image (one centimeter square) was measured with Spectrodensitometer (938, X-Rite Incorporated). The image density measuring 1.1 or over was rated good.

The fixing capabilities were evaluated by the following means on the following basis. A strip of adhesive tape (Scotch mending tape, Sumitomo 3M Limited) was stuck on a solidly shaded image (one centimeter square) and then was unstuck. The image densities before and after the tape was unstuck were measured with Spectrodensitometer (938, X-Rite Incorporated), and the ratios of the image density before unstuck to after unstuck were determined by percentage to evaluate the fixing capabilities. The fixing capability of 80% or higher was rated good.

The blur production was evaluated by the following means on the following basis. Feret's diameters of dots image having area rate of 5% were measured with dot analyzer (DA-5000S, Oji Scientific Instruments K.K.). The blur production was determined from the ratios of the Feret's diameters to nozzle diameters.

### EXAMPLES 2 THROUGH 7

The same process as of Example 1 was repeated by using monomer compositions shown in Tables 1 and 2. The abbreviations used in Tables 1 and 2 stand for the following terms.

2EHA: 2-ethylhexyl acrylate

MAA: methacrylic acid

MBM: monobutyl maleate

BQA: 2-hydroxypropyl-N,N,N-trimethylammonium chloride acrylate

DMA: dimethylaminoethyl acrylate

LMA: lauryl methacrylate

VP: vinylpyridine

DMPC: N,N-diallylmethylammonium chloride

### EXAMPLE 8

Preparation of Resin Latex

| | |
|---|---|
| Styrene monomer (St) | 70 wt % |
| Lauryl methacrylate (LMA) | 40 wt % |
| N, N-diallylmethylammonium chloride (DMPC) | 10 wt % |

The mixture of the above monomers was added to the aqueous solution of:

| | |
|---|---|
| Water | 100 wt % |
| Disazo yellow pigments | 40 wt % |
| Emargen 950 | 1 wt % (emulsion) |
| Neogen R | 1.5 wt % (emulsion) |
| Potassium persurfate | 0.5 wt %, |

agitated and polymerized at 70° C. for eight hours, a resin latex with a solids content of 50% was obtained. The volume average particle diameters were measured with Microtrac UPA (Nikkiso Co., Ltd.) and turned out to be 0.1 μm. A part of the resin latex was sampled, filtered with the Buchner funnel, washed in the water and vacuum-dried at 50° C. for ten hours. The glass transition point was measured with SSC/5200 (Seiko Instruments Inc.) and turned out to be 15° C., while the softening point was measured with Flow Tester (Shimadzu Corporation) and turned out to be 92° C.

Preparation of Inkjet Ink

| | |
|---|---|
| Resin latex | 50 wt % |
| Diethylene glycol | 25 wt % |

The above materials were agitated and uniformly mixed for two hours with DISPERMAT SL-12 (Summit Chemtec Co., Ltd.). The liquid dispersion obtained through this process was then diluted with water of 400 wt %, and consequently inkjet ink was obtained. The viscosity of the ink was measured with DIGITAL VISCOMETER DVM-E (Tokimec Inc.) and turned out to be 10 cP.

When the above ink was filled into an ink-on-demand inkjet printer (nozzle diameter: φ 40 μm, number of nozzles: 24) and inkjet recordings were executed, little-blurred high-density images were obtained.

### Comparative Example 1

Ink compositions were prepared by repeating the procedure of Example 1 with the exception that there was no resin latex included.

Preparation of Inkjet Ink

| | |
|---|---|
| Phthalocyanine blue pigments | 25 wt % |
| Diethylene glycol | 25 wt % |

The above materials were agitated and uniformly mixed for two hours with DISPERMAT SL-12 (Summit Chemtec Co., Ltd.). The liquid dispersion obtained through this process was then diluted with water of 400 wt %, and consequently inkjet ink was obtained. The viscosity of the ink was measured with DIGITAL VISCOMETER DVM-E (Tokimec Inc.) and turned out to be 5 cP.

When the above ink was filled into an ink-on-demand inkjet printer (nozzle diameter: φ 40 μm, number of nozzles: 24) and inkjet recordings were executed, much blurred low-density images were obtained.

While the present invention has been described above in its preferred embodiments and examples, the present invention is not limited to these embodiments but various variations and modifications may be made without departing from the spirit and scope of the present invention.

As described above, according to the ink, ink cartridge and recording device of the present invention, a high-quality image satisfactorily reproducing an original image color, having more easily fixing and rapid-drying properties than conventionally can be inexpensively provided. Furthermore, the ink of the present invention may facilitate a cost reduction of the recording device due to its self-fixing capability.

What is claimed is:

1. Ink comprising
a primary particle of a copolymer obtained from at least one kind of a radical polymeric monomer;
a colorant; and
a solvent that is liquid at room temperature.

2. The ink according to claim 1, wherein said primary particle of a copolymer is prepared by a polymerization process selected from the group consisting of an emulsion polymerization, a micro emulsion polymerization and a soap-free polymerization.

3. The ink according to claim 1, wherein said primary particle of a copolymer has a volume average particle diameter ranging from 0.01 through 2 μm.

4. The ink according to claim 1, wherein said copolymer has a glass transition point ranging from −30 through 70° C.

5. The ink according to claim 1, wherein said copolymer has a softening point (by a flow tester) ranging from 40 through 150° C.

6. The ink according to claim 1, wherein said colorant comprises one selected from the group consisting of a pigment and a dye, and said colorant is dissolved or dispersed in said primary particle of a copolymer.

7. The ink according to claim 1, wherein said colorant comprises one selected from the group consisting of a pigment and a dye, and said colorant is adsorbed on or coats a surface of said copolymer.

8. The ink according to claim 1, wherein said colorant comprises one selected from the group consisting of a pigment and a dye, and said colorant is dissolved or dispersed in said solvent.

9. The ink according to claim 1, wherein said copolymer is included at 1 through 50 wt %.

10. The ink according to claim 1, wherein said colorant is included at 0.1 through 20 wt %.

11. The ink according to claim 1, wherein at least one kind of said radical polymeric monomer is selected from the group consisting of:
(a) styrene and styrene derivative; and
(b) alkyl acrylate, alkyl metacrylate and derivatives thereof.

12. The ink according to claim 1, wherein said copolymer includes 20 through 99 wt % of styrene and styrene derivative in the whole.

13. The ink according to claim 1, wherein said copolymer includes 10 through 80 wt % of alkyl acrylate, alkyl metacrylate and derivatives thereof in the whole.

14. Ink comprising:
a copolymer particle obtained from at least one kind of a radical polymeric monomer;
a colorant; and
a solvent that is liquid at room temperature.

15. The ink according to claim 14, further comprising a surfactant covering a surface of said copolymer particle.

16. An ink cartridge including a case and ink which is stored in said case and comprises:
a copolymer particle obtained from at least one kind of a radical polymeric monomer;
a colorant; and
a solvent that is liquid at room temperature.

17. A recording device including a head and an ink cartridge supplying ink to said head, wherein said ink comprises:
a copolymer particle obtained from at least one kind of a radical polymeric monomer;
a colorant; and
a solvent that is liquid at room temperature.

18. A recording device according to claim 17, wherein said head is a piezo-type inkjet head.
